(19) United States
(12) Patent Application Publication
(10) Pub. No.: US 2026/0156723 A1
(43) Pub. Date: Jun. 4, 2026

(54) HANDOVER OF COOKWARE BETWEEN COOKING ZONES

(71) Applicant: Ztove APS, Odense S (DK)

(72) Inventor: Peter Aagaard Favrholdt, Odense M (DK)

(21) Appl. No.: 19/126,893

(22) PCT Filed: Nov. 3, 2023
(86) PCT No.: PCT/DK2023/050267

§ 371 Date: May 2, 2025

(30) Foreign Application Priority Data
Nov. 4, 2022 (DK) PA202270536

(51) Int. Cl. H05B 6/12

(52) U.S. Cl. CPC H05B 6/1209; H05B 2213/06

(57) ABSTRACT

Disclosed is a method of operating an induction cooking system comprising the steps of; providing an induction cooking system comprising one or more induction hobs comprising a plurality of cooking zones; placing an induction cookware on a first cooking zone of said plurality of cooking zones, the induction cookware comprising one or more sensors; assigning a cooking setting to said first cooking zone; transferring, by a user of said induction cooking system, said induction cookware to a second cooking zone of said plurality of cooking zones; automatically detecting by said induction cooking system, said transferring using sensor input provided by said one or more sensors; and automatically assigning a corresponding cooking setting to said second cooking zone. An induction cooking system and an induction cooking zone are further disclosed.

### FIELD OF THE INVENTION

The present invention relates to a method of operating an induction cooking system, an induction cooking system, and an induction cooking zone.

### BACKGROUND OF THE INVENTION

During cooking, users typically shift the position of a cookware from one place on a hob to another place on the hob, such as from one cooking zone to another cooking zone of the hob. Such situations may arise when a user is preparing food using a cookware that is placed on a cooking zone near the user, and at some point, the cooking process requires less attention, at which the user shifts the cookware to another, possibly more distant, cooking zone to make place for another cookware requiring more attention. Such a shift in cookware placement from e.g., a first cooking zone to a second cooking zone may not be effortless as the user may have to configure hob settings for the second cooking zone in order for the cooking process to proceed as intended. Cooking hobs typically have pre-defined power settings for individual cooking zones, such as pre-defined power steps 1-9 (possibly also an additional boost level) which corresponds to specific amounts of power delivered to a cookware placed on the respective cooking zone. However, the individual power steps may vary from cooking zone to cooking zone. For example, on a typical hob, such as an induction hob, one cooking zone may be configured to delivering a maximum of 1200 Watts at the highest power step, whereas a neighbouring second cooking zone may be configured to delivering a maximum of 2400 Watts at its highest power step. Therefore, if the user has been cooking at power step 4 on one cooking zone, the user may have to use a different power step, for example power step 6, on the cooking zone to which the cookware is shifted in order to continue the cooking process in a similar manner. In the worst possible scenario, the cooking process is a very delicate process requiring e.g., a specific temperature, but this temperature cannot be accurately reproduced for the cookware using other cooking zones than the one in use. In this scenario, the user cannot shift position of the cookware without negatively affecting the cooking process.

### SUMMARY OF THE INVENTION

The inventors have identified the above-mentioned problems and challenges related to shifting of cookware placement, and subsequently made the below-described invention which may result in a more seamless cooking experience.

An aspect of the present invention relates to a method of operating an induction cooking system comprising the steps of:
providing an induction cooking system comprising one or more induction hobs comprising a plurality of cooking zones;
placing an induction cookware on a first cooking zone of said plurality of cooking zones, wherein said induction cookware comprises one or more sensors;
assigning a cooking setting to said first cooking zone;
transferring, by a user of said induction cooking system, said induction cookware to a second cooking zone of said plurality of cooking zones;
automatically detecting, by said induction cooking system, said transferring of said induction cookware using sensor input provided by said one or more sensors of said induction cookware; and
automatically assigning a corresponding cooking setting to said second cooking zone.

Thereby is provided an advantageous method of operating an induction cooking system. The method facilitates an automatic handover of cookware from one cooking zone to another without unnecessary interruption of the cooking process. Thereby is achieved seamless cooking experience where a user of the induction cooking system is liberated from the task of fine-tuning induction hob settings once a cookware has been transferred to a new cooking zone, and the user is thus free to concentrate on what matters, namely the cooking processes.

In the context of the present invention an “induction cooking system” is understood as a system comprising any number of induction hobs and any number of induction cookware. For example an induction cooking system according to the present invention may according to one embodiment of the invention comprise a single induction hob and a single induction cookware, however, in other embodiments of the invention the induction cooking system may comprise any number of induction hobs and any number of induction cookware, for example one induction hob and a plurality of pieces of induction cookware such as two pieces of induction cookware, two induction hobs and a single piece of induction cookware, and two induction hobs and a plurality of pieces of induction cookware, such as two pieces of induction cookware, for example 4 pieces of induction cookware.

In the context of the present invention, the term “cookware” is understood as any kind of cooking receptacle or cooking vessel in (or on) which food is placed when being cooked. The term cookware may thus encompass any type of cooking receptacle or cooking vessel including cooking pots such as sauce pots, stock pots and stew pots and cooking pans such as saucepans, saucier pans, sauté pans, frying pans, grill pans and wok pans. Furthermore, within the context of the present invention, the term “cookware” is understood as a kind of cooking receptacle or cooking vessel arranged to be placed on a hob for the purpose of cooking food.

By the term hob may also be understood a cooktop or a stove. A hob is configured to provide heating to cookware placed thereon through different heating mechanisms depending on the type of the hob. A gas hob delivers heating energy through burning of a gas, a ceramic hob delivers heating through heat radiation, and an induction hob delivers heating through induction. Of these types of hobs an induction hob is typically the most precise, reactive, and energy efficient, and for these reasons induction hobs are gaining grounds among consumers of household products but also in professional kitchens.

Thus, the term “induction cookware” is understood as any kind of cooking receptacle, or cooking vessel as indicated above which is at least capable of being heated through induction on an induction hob.

In the context of the present invention, a “cooking zone” is understood any area (or section) of a surface of the induction hob that is usable for cooking and through which inductive power can be supplied to induction cookware placed thereon. As such an induction hob may comprise dedicated cooking zones, such as four cooking zones, and the cooking zones may be arranged in any way on the induction hob, for example in a quadratic shape with each zone defining a corner of the shape, however, a cooking zone according to the present invention is not limited to such a visual definition of a zone. In fact, a cooking zone of an induction hob need not be visible to the user of the induction hob, as for example is the case of zoneless induction hobs also referred to as “free induction hobs”. Such free induction hobs may comprise a plurality of induction coils, such as more than four induction coils, such as more than ten induction coils, for example 40 induction coils. Therefore, a cooking zone may be defined as an area (or section) of an induction hob comprising at least one induction coil arranged for the purpose of cooking using an induction cookware placed on the zone.

In the context of the present invention, the term “cooking setting” is understood as a parameter, or a set of parameters, relating to the cooking of food items in the induction cookware. Cooking settings may relate to specific parameters relating to hardware components of the induction cooking system, such as power supplied by one or more induction coils of the induction hob, and/or they may relate to specific parameters directly involved in the cooking process (or a recipe) such as temperatures and timing. As such, the cooking setting may define a target condition to be reached in the induction cookware, and/or it may describe a present condition in the induction cookware. In other words, a cooking setting may describe present conditions but may also prescribe future conditions of a cooking process occurring in the induction cookware. Below is given a non-exhaustive list of possible cooking settings:
Target temperature of the induction cookware
Power supplied to the induction cookware
Remaining time of cooking process or remaining time of a sub-step of the cooking process
Time-dependent power setting (a specific amount of inductive power to be supplied for a certain amount of time)
Time-dependent temperature setting (a specific target temperature of the induction cookware to be maintained for a certain amount of time)
A state of the induction cookware (such as a cooling state in which no power is supplied to the cookware)
A cooking recipe

It should be noted that the cooking setting according to the present invention may comprise any combination of the above settings. Furthermore, the cooking setting may include a cooking recipe, such as a sequence of settings.

In the context of the present invention, a “corresponding cooking setting” is understood as a cooking setting which when used by the second cooking zone results in the continuation of the cooking process which occurred when the induction cookware was placed on the first cooking zone and subjected to the cooking setting. Here below are given numerous examples of correspondences between a cooking setting and a corresponding cooking setting. If the cooking setting is a target temperature of the induction cookware, the corresponding cooking setting may be the same target temperature. If the cooking setting is a present power supplied to the induction cookware, the corresponding cooking setting is the same power (inductive power supplied by induction hob). If the cooking setting is a cooking recipe being autonomously executed by the induction cooking system, the corresponding cooking system may be the remaining part of the cooking recipe which has not been executed yet. A skilled reader will readily appreciate that the corresponding cooking setting is a cooking setting applied for a second cooking zone, which setting ensures that the conditions of the induction cookware, or process being undertaken by the induction cookware, when the cookware was present on the first cooking zone, are carried over to the second cooking zone.

It should be noted that by assigning a cooking setting is understood that a cooking setting is selected for the cookware positioned on the first cooking zone such that the cooking process can occur using the first cooking zone in accordance with the cooking setting. The very act of assigning a cooking setting should therefore not be construed in such a limiting way that it is only a power setting of the first cooking zone that is assigned, however, the act of assigning a cooking setting may also be construed in such a way that the assignment includes storing the cooking setting in the induction cookware, e.g., in a digital memory of the induction cookware, and having the cookware control the cooking process according to that cooking setting by communicating e.g., power instructions to the cookware. That the assignment of a cooking setting is to be construed in a not-so limiting way is immediately evident by the nature of the cooking settings which may include other parameters than merely power supplied to the inductive cookware. In such situations where the inductive cookware has the cooking setting assigned in a digital memory, and where the cookware has the initiative in the control of the cooking process, power instructions may be transmitted by the cookware to the cooking hob. Such power instructions may include asking the cooking hob to have the first cooking zone delivering a certain inductive power or increasing/decreasing applied inductive power. It therefore also follows that the corresponding cooking setting may be assigned to the memory of the cookware in a similar way, albeit in an automated fashion.

According to an embodiment, the one or more sensors of said induction cookware comprises one or more temperature sensors.

The induction cookware may comprise one or more temperature sensors. By temperature sensor is understood any kind of device capable of measuring temperature. Such sensors may include RTD's (Resistance Temperature Detectors), thermocouples, thermistors, or any other kind of device capable of establishing a temperature of a physical object. The one or more temperature sensors may be arranged in the cookware in such a way that they may detect temperature(s) relevant to cooking processes occurring in the cookware during use. Preferably, the one or more temperature sensors are arranged in a base part of the induction cookware, however the one or more temperature sensors may also be arranged in a sidewall of the cookware. The base part of the induction cookware is the part of the cookware that is in contact with the induction hob during cooking. The base part of the cookware may comprise one or more material layers configured to being inductively heated by an induction hob. For example, the one or more material layers may comprise a ferromagnetic material layer. An induction cookware comprising one or more temperature sensors is advantageous in that cooking processes occurring in the cookware may be monitored.

According to an embodiment, said induction cookware comprises a digital memory.

The induction cookware may comprise a digital memory. By a digital memory is understood any kind of device capable of storing digital data, such as a non-volatile memory, for example flash memory storage and solid state drive, or a volatile memory, for example RAM (random-access memory), including DRAM (dynamic RAM) or SRAM (static RAM). A skilled person will readily appreciate that many types of digital data memory exist and will choose the type of memory most suitable to the specific needs of the cookware. It should be noted that the induction hob may also comprise a digital memory of any of the types described in the above.

According to an embodiment, said digital memory stores a cookware identifier identifying said induction cookware in said induction cooking system. The cookware identifier may be any kind of digitally implemented identification capable of uniquely identifying the induction cookware in the induction system, for example to identify the induction cookware among a plurality of induction cookware. Examples of such a cookware identifier may include a digital serial number and a user-assigned names or numbers.

According to an embodiment, said method comprises a step of assigning said cooking setting to said cookware identifier.

When a cooking setting is assigned to the first cooking zone the a further assignment of the cooking setting may be made by assigning the cooking setting to a cookware identifier of the induction cookware. Assigning a cooking setting to a cookware identifier may be construed as a digital assignment, such as a digital assignment performed by a data processing arrangement of the induction cooking system. Assigning a cooking setting to a cookware identifier is advantageous in that a cooking setting may effectively be assigned to the cookware itself and the induction cooking system may at any time be aware of the cooking setting assigned to the cookware, irrespective of whether the cookware is subsequentially removed from the first cooking zone. Put in other words, the additional assignment of the cooking setting to the cookware identifier enables the cooking setting to follow the induction cookware as the cookware is moved from cooking zone to cooking zone, or even from cooking hob to cooking hob, of the induction cooking system.

According to an embodiment, said step of automatically assigning a corresponding cooking setting to said second cooking zone is performed on the basis of said cookware identifier.

The step of automatically assigning the corresponding cooking setting may be performed on the basis of the cookware identifier. This is advantageous in that the assignment of the corresponding cooking setting may be based on a cooking setting already assigned to the cookware identifier. For example, the induction cookware system may, upon the automatic detection of the transfer, not only establish that the induction cookware with a given cookware identifier was transferred, but the induction system may also know what cooking setting was previously assigned to that specific piece of cookware, and accordingly assign a corresponding cooking setting to that cookware. For example, if a cooking recipe is initially assigned to the first cooking zone, that setting is also assigned to the cookware identifier. The induction cooking system may detect that a cookware with that identifier is moved to a new position on the cooking hob, and knowing what cooking recipe was initially assigned to the identifier, the new corresponding cooking setting may correspond to that initial cooking recipe, thereby facilitating that a recipe may be initiated on a first cooking zone and carried over, along with the induction cookware, to a second cooking zone for e.g., completion.

According to an embodiment, said induction cooking system is configured to automatically detect said transferring of said induction cookware from said first cooking zone to said second cooking zone.

The induction cooking system may be configured to automatically detect that the induction cookware is transferred from the first cooking zone to the second cooking zone. Such automatic detection may be facilitated by use of one or more sensors, such as one or more sensors of the induction cookware, or alternatively by use of external devices including for example a camera system. Automatically detecting a transfer of a cookware from a first cooking zone to a second cooking zone is advantageous in that an autonomous carryover of cooking settings may be possible. With the automatic detection of a transfer it is not only ensured that a corresponding cooking setting is used for the cookware placed on the second cooking zone, the cooking setting may be automatically assigned without any intervention by the user of the system as the user do not have to indicate which cooking zone the induction cookware is moved to (and which cooking zone it is moved from) for the automatic assignment of cooking settings to occur. This gives the user of the induction cooking system the full freedom as once a cooking setting is applied to a cooking zone on which the cookware is placed, the user may move the cookware to any other cooking zone of the system without considering whether cooking settings should be changed as a result of the transfer.

According to an embodiment, said automatic detection is established on the basis of one or more measurements relating to a magnetic field and/or an electric field generated by said one or more induction hobs, said one or more measurements being provided by said one or more sensors of said induction cookware.

During operation, an induction hob supplies its induction coil(s) with alternating electric current of frequencies typically in the order of tens of kilohertz. This induces alternating magnetic field(s) that are usable for supplying inductive power (heating power) to an induction cookware once the cookware is placed over the cooking zone corresponding with the induction coil(s). Additionally, to the generation of a magnetic field, an electric field may also be generated by the cooking hob. The one or more sensors of the induction cookware may measure these fields in numerous ways. For example, by implementing a wire loop as a dedicated wire loop or as part of a sensor wiring, it is possible to measure induced current in the wire loop. This induced current relates to magnetic field. Additionally, it is possible to measure electric field coupling (also called capacitive coupling) using multiple wires, for example dedicated wires or wires forming part of the wiring of the one or more sensors of the induction cookware. Such measurements may be used as basis for detection of cookware position on induction hobs and may thus advantageously be used as a basis for the automatic detection of cookware transfer.

An alternating magnetic field may be modulated in various ways which are known to the skilled person, including pulse amplitude modulation (PAM) and pulse width modulation (PWM), such that the alternating magnetic field produced at a cooking zone comprises a signature unique to that cooking zone. Other usable modulation techniques include PDM (Pulse-density modulation). A measurement relating to the magnetic field produced at a cooking zone may reflect this unique signature and thereby from the measurement it may be deduced which cooking zone the measurement is a measurement of. Thus, by the induction cookware providing a measurement relating to magnetic field, the induction cooking system is capable of detecting both which cooking zone the induction cookware was placed on and also which cooking zone the induction cookware was transferred to. In addition to the above modulation, or as an alternative thereto, there may also be other suitable detection mechanisms including the following which detection mechanism which is based on the fact that the cooking hob may already know whether an induction cookware is placed on one of its cooking zones or not, as well as the timing involved with detection of an alternating magnetic field. When an induction cookware is placed/or removed from a cooking zone of an induction hob, the induction hob may automatically establish a point in time at which the placement/removal took place. Likewise, when the cookware is placed on (or removed from) a cooking zone the cookware may also establish a point in time in which an alternating magnetic field is measured (or not). By correlating these points in time, the induction cooking system may deduce that a transfer of cookware has been made.

According to an embodiment, said automatic detection is performed by a data processing arrangement of said induction cooking system, said data processing arrangement correlating measurements provided by said one or more sensors of said induction cookware with a power status of said one or more induction hobs.

The induction cooking system may at all times be aware of how much power is supplied by each cooking zone of the plurality of cooking zones, i.e., the power status of the one or more induction hobs. By correlating the power status, and particular changes in power status, with measurements provided by one or more sensors of the induction cookware, it may be possible for the induction cooking system to determine the position of individual pieces of cookware, and to automatically detect transfers thereof.

For example, the one or more sensors of the induction cookware may comprise a temperature sensor which is installed in a base part of the induction cookware using wires. The arrangement of the wires may form a wire loop in which current may be induced by an alternating magnetic field generated by one or more induction coils of the cooking zone on which the induction cookware is placed. The implication thereof is that the induced current may be manifested as noise in a temperature signal of the temperature sensor. Increasing the power supplied by the induction coils may amplify the noise in the temperature signal. Thus, a change in power induced may be measured as a change in noise on a temperature signal, and thus correlating a power status with such measurements, it may become possible to determine the position of the induction cookware.

According to an embodiment, said one or more sensors comprises a wire loop.

The wire loop may be implemented as a dedicated wire loop or as part of another component of the induction cookware such as a part of a sensor, for example a temperature sensor, or as part of an energy harvesting coil. A wire loop is ideally suited to detect changes in a magnetic field. The changing magnetic field imposed by induction coils in the induction hob induces a current in the wire loop, and this induced current may be correlated with known signals provided by the induction hob to determine which cooking zone the induction cookware is placed on.

According to an embodiment, said one or more sensors comprises an accelerometer.

The induction cookware may comprise an accelerometer. By an accelerometer is understood any kind of electronic device capable of measuring accelerations/vibrations in at least one direction. The accelerometer may be arranged to measure accelerations/vibrations in at least one direction/axis of vibration, such as at least two directions, for example three directions. Measuring vibrations in multiple directions/axis of vibrations is advantageous in that more vibrational modes of the cookware may be measured than if measurements are only performed for a single direction/axis. Measuring vibrations of the induction cookware using an accelerometer is advantageous since vibrations of the cookware can be correlated with the frequency of the magnetic field imposed by induction coil(s) of the induction hob, and therethrough the position of the induction cookware on the induction hob may be determined.

The induction cookware may comprise one or more temperature sensors capable of detecting temperature(s) of the induction cookware. Detecting a temperature is advantageous for a number of reasons specific to cooking, however, detecting a temperature may also be useful for the purpose of identification of cookware. The temperature response of the cookware as measured by the temperature sensor when inductive power is supplied may be used by the cookware to estimate the inductive power supplied to the cookware. The estimated inductive power may be correlated with actual power supplied by induction coil(s) of the induction hob, and thereby the position of the induction cookware on the induction hob may be determined. It should be noted that although a temperature sensor measures temperature which is not directly a measure of magnetic field, measurements provided by the temperature sensor are indirectly relating to the magnetic field experienced by the induction cookware, as the temperature of the cookware is a physical result of the inductive power applied to the cookware through the magnetic field generated by the induction hob.

According to an embodiment, said automatic detection is established using a camera system.

The detection of a transfer of the induction cookware from the first cooking zone to the second cooking zone may be carried out by use of a camera system. The camera system may be configured to capture a plurality of images of the cookware and track the placement of the cookware and movements thereof by use of computer vision.

It should be noted that although several different ways of detecting cookware placement have been disclosed it is not understood that cookware placement may only be determined using a single detection method. In fact, multiple detection methods may be used in conjunction to determine cookware placement, thereby improving accuracy of the determination. For example, multiple sensor inputs may be used together to determine cookware placement (and thus transfer of the cookware), or an external device, e.g., a camera using computer vision, may track the placement of the cookware and movements thereof.

According to an embodiment, said induction cooking system comprises a data processing arrangement configured to automatically detect said transferring of said induction cookware from said first cooking zone to said second cooking zone on the basis of sensory input.

The induction cooking system may comprise a data processing arrangement configured to automatically detect said transferring of said induction cookware from said first cooking zone to said second cooking zone on the basis of sensory input. In the context of the present invention, a “data processing arrangement” is understood as a computer processing unit, or arrangement of computer processing units, capable of electronic processing of data such as a microprocessor, a microcontroller, a central processing unit (CPU), or a field programmable gate array. Furthermore, in the context of the present invention, “sensory input” is understood as input provided by at least one or more sensors, such as a wire loop sensor, a temperature sensor, an accelerometer, or input provided by a camera system, including images obtained by the camera system. The data processing unit may be arranged in the induction cookware, in the induction hob, or in another electronic device such as a handheld electronic device for example a smartphone, a smartwatch, a tablet or a laptop. In fact, the data processing arrangement may be distributed across any of the induction hob, the induction cookware and an electronic device (if the induction cooking system comprises such an electronic device).

According to an embodiment, said input interface comprises a graphical user interface, wherein said step of assigning said cooking setting to said first cooking zone comprises displaying said assignment of said cooking setting on said graphical user interface, and wherein said step of automatically assigning said corresponding cooking setting to said second cooking zone comprises displaying said assignment of said corresponding cooking setting on said graphical user interface.

The input interface may comprise a graphical user interface facilitating a user of the system to assign a cooking setting to a cooking zone. The graphical user interface may facilitate the user being able to define the cooking setting or to select a cooking setting among e.g., a plurality of cooking settings. For example, the user may select, using the graphical user interface, a cooking recipe among a plurality of predefined cooking recipes. In addition, the graphical user interface may also display the assignment of the cooking setting, meaning that the graphical user interface may display what cooking setting is being executed for any particular cooking zone. This is advantageous in that it gives the user a great overview of the cooking process and in particular when multiple cookware is being used at the same time. It is particular advantageous in that the assignment of the corresponding cooking setting is also displayed using the graphical user interface, as this enables the user to keep track of the cooking process even when the cookware is being moved from cooking zone to cooking zone.

According to an embodiment, said input interface forms part of an external electronic device of said induction cooking system.

The input interface may form part of an external electronic device. By an external electronic device is understood any kind of electronic device capable of controlling, interacting with, and/or monitoring the induction cooking system. The electronic device is external in the sense that it is not directly involved in a cooking process in the same way that an induction hob and an induction cookware are. Examples of such external electronic devices include handheld electronic devices such as smartphones, smartwatches, tablets, or laptops.

According to an embodiment, said step of assigning said cooking setting to said first cooking zone is carried out by a user assigning said cooking setting using an input interface of said induction cooking system.

The assigning of a cooking setting to the first cooking zone may be carried out by a user of the induction cooking system. The user may assign the cooking setting by use of an input interface of the induction cooking system. The input interface may directly form part of the induction hob and/or the induction cookware, such as through arrangement of physical input means, including buttons, toggle switches and touch switches, on the induction hob and/or the induction cookware. Alternatively, the input interface may be facilitated by an external electronic device (external from the induction hob and induction cookware). By external device may be understood an electronic device such as a smartphone, a tablet, a smartwatch a laptop, or any other electronic device, including a remote control, suitable for electronic communication with an induction hob and/or an induction cookware. Such electronic communication may be facilitated by various communication protocols including Bluetooth, such as Bluetooth low energy (BLE), WiFi, cellular communication protocols including 3G, 4G, LTE and 5G, and other wireless communication protocols such as Zigbee and Z-Wave.

According to an embodiment, said step of assigning said cooking setting to said first cooking zone is carried out automatically by said induction cooking system on the basis of detection of placement of said cookware on said first cooking zone.

The induction cooking system may be configured to detect placement of the cookware on the first cooking zone, and automatically assign the cooking setting to the first cooking zone. This is particularly advantageous in professional kitchens where particular cooking zones may be used for the same cooking purposes throughout a working day. In other words, the cooking zone in question may be dedicated for a particular cooking process. By the induction cooking system automatically assigning the cooking setting to the first cooking zone upon detection of the cookware on that zone is advantageous in that a user may not need to assign any cooking setting for a cooking process to initiate. Thereby a more seamless cooking experience may be achieved.

According to an embodiment, said step of automatically assigning said corresponding cooking setting to said second cooking zone is performed upon automatic detection of said transferring of said cookware from said first cooking zone to said second cooking zone.

The induction cooking system may automatically assign the corresponding cooking setting in response to automatically detecting the transferring of the induction cookware from the first cooking zone to the second cooking zone. Thereby is achieved an advantageous method of operating an induction cooking system which requires very little user intervention.

According to an embodiment, said cooking setting comprises temperature.

The cooking setting may advantageously comprise temperature. By “temperature” is understood a temperature of the induction cookware relating to a cooking process occurring in (or on) the induction cookware. For example, the temperature may refer to a temperature of a cooking surface of the induction cookware, which surface comes into contact with food items and/or liquids during cooking. Using temperature as a cooking setting is advantageous in that it may facilitate reproduction of cooking recipes that require accurate temperature control.

According to an embodiment, said cooking setting comprises power.

The cooking setting may advantageously comprise power. By “power” is understood a power supplied to the induction cookware by means of induction. Using power as a cooking setting is advantageous if a user of the induction cooking system is accustomed to a specific piece of induction cookware and knows what cooking effect is achieved at specific power levels.

According to an embodiment, said cooking setting comprises power density.

By power density is understood inductive power supplied per area.

According to an embodiment, said cooking setting comprises time.

The cooking setting may advantageously comprise a time. By “time” is understood a time period pertaining to a cooking process in the induction cookware. For example, the time may specify a remaining time of a cooking process or at least a remaining time of at least a part of a cooking process.

According to an embodiment, said cooking setting is a time-dependent cooking setting.

By a time-dependent cooking setting is understood a cooking setting which is applied for a certain pre-determined time duration and/or a cooking setting which is dynamic over time, i.e., changes in a pre-defined way over time. A time-dependent cooking setting is advantageous in that it facilitates execution of a cooking recipe, such as at least partly, or fully, automation of a cooking recipe. A cooking recipe may vary in complexity and in its most simple form it may prescribe a specific power or temperature for a given time duration, for example 2000 watts or 150 degrees Celsius for 20 minutes. More advanced forms of a cooking recipe prescribe a plurality of different power/temperature levels for corresponding pluralities of time durations/time sections. Such an advanced cooking recipe may for example prescribe a specific power or temperature for a first time period, such as 2000 watts or 150 degrees Celsius for 20 a first time period of 20 minutes, followed by another specific power or temperature for a second time period, such as 1000 watts or 95 degrees Celsius for a second time period of 40 minutes.

According to an embodiment, said time-dependent cooking setting comprises a temperature profile.

In the context of the present invention, a “temperature profile” is understood a time sequence of temperature settings. The temperature profile prescribes a temporal evolution of the temperature of the induction cookware. The temperature profile may include a sequence comprising a plurality of steps, each step prescribing at least one temperature and a corresponding time duration. For example, the sequence may include a first step prescribing that a temperature of 220 degrees Celsius is intended to be maintained for 5 minutes followed by a step of maintaining a temperature of 150 degrees Celsius for 10 minutes. In fact, the temperature profile may include any combination of steps prescribing any temperature and time duration. The temperature profile may also include steps prescribing intended time derivatives of temperature, i.e., prescribing how slowly/quickly the temperature should increase/decrease during the step. Having a temperature profile as a cooking setting is advantageous in that specific cooking recipes may be executed using the induction cooking system.

According to an embodiment, said cooking setting is a time-dependent cooking setting, and wherein said corresponding cooking setting comprises an unelapsed part of said cooking setting.

Having the corresponding cooking setting comprising an unelapsed part (not yet processed part) of the time-dependent cooking setting is advantageous in that it facilitates a transfer of time-dependent cooking setting. Thereby a cooking recipe can effectively be assigned to an induction cookware placed on one cooking zone and the cooking recipe can follow along with the induction cookware from cooking zone to cooking zone and having parts (time sections) of the time-dependent cooking setting being processed using a plurality of cooking zones.

According to an embodiment, said cooking setting is a cooking recipe.

According to an embodiment, said cooking setting is a cooking recipe, and wherein said corresponding cooking setting is a corresponding cooking recipe.

According to an embodiment, said cooking recipe is selected among a plurality of cooking recipes, by a user selecting said cooking recipe using an input interface.

Throughout the present disclosure, a “cooking recipe” may be understood as an automatically executed sequence of cooking instructions which when executed achieves a desired cooking result in the cookware. Examples of cooking recipes may be a rice cooking recipe, a potato cooking recipe, a bearnaise sauce recipe, a pancake recipe, or any other kind of recipe which can be carried out using induction cookware. Depending on the specific recipe to be executed, the cooking recipe may take various forms, and for example, the cooking recipes may differ in cooking temperatures and cooking times, and some cooking recipes may even include multiple temperatures maintained at respective time intervals, and the cooking recipe may even include temperature gradients, i.e., the cooking recipe may for example include a warming up or cooling down phase. Clearly from the above, a cooking recipe differs from the settings which may typically be used for cooking in prior art cooking systems where a user selects a power level between “one” and “nine” for any cooking zone, as the cooking recipe may include automatic transitions between power levels and control timing aspects of the cooking process. The user of the system may for example choose any given cooking recipe using an input interface of the system, for example using a graphical user interface of an external electronic device, e.g., a smartphone. When choosing the recipe, for example a rice cooking recipe, the user may select that recipe among a plurality of recipes presented using the input interface. Being able to utilize cooking recipes as cooking settings is particular advantageous in that the cooking processes can be more automatized, and the user may be able to focus on other tasks involved in preparing a meal. Thereby, a more stress free cooking experience may be achieved.

It should be noted that although several kinds of cooking settings have been disclosed it is not understood that a cooking setting can only be a single one of these. In fact, multiple cooking settings, such as any of the cooking settings described in the preceding provisions, may be used in conjunction.

According to an embodiment, a plurality of induction hobs are provided including a first cooking hob and a second cooking hob, wherein said first cooking zone forms part of said first induction hob, and wherein said second cooking zone forms part of said second induction hob.

The method may advantageously facilitate handover of an induction cookware from one induction hob to another induction hob. This is advantageous for example in large kitchens, such as restaurant kitchens including multiple induction hobs and multiple cooks, where cookware may regularly need to be shifted in position to accommodate for the multiple cooking processes occurring in such a kitchen.

According to an embodiment, said induction cookware is a first induction cookware and wherein said method comprises a further step of placing a second induction cookware on the first cooking zone after said first induction cookware is transferred to said second cooking zone and assigning a new cooking setting to said first cooking zone.

The method may facilitate handling of multiple pieces of induction cookware, including a switch of cookware on a cooking zone from a first induction cookware to a second cookware. This is advantageous in that multiple different cooking processes may occur through the same cooking zone. Thus, a user, such as a cook in a kitchen can maintain his/her position at a cooking station and have multiple different cooking processes passing through at a cooking zone close to the user in the kitchen. The new assigned cooking setting may be a corresponding cooking setting in the sense that it is a cooking setting that is corresponding to a cooking setting of a cooking zone where the second induction cookware was placed prior to the second induction cookware being transferred to the first cooking zone.

According to an embodiment of the invention the previous position (i.e., cooking zone) of the second induction cookware may be the second cooking zone. Thereby is achieved a method which may advantageously facilitate a switch of induction cookware between two cooking zones of an induction cooking system.

According to an embodiment, said induction cooking system is configured to distinguish between an act of picking up said induction cookware from said first cooking zone and putting back said induction cookware on said first cooking zone and an act of transferring said induction cookware from said first cooking zone to said second cooking zone.

According to the present invention, a transfer of a cookware is only completed if the cookware is removed from the first cooking zone and placed on the second cooking zone. Thus, any other act of moving the induction cookware is not to be mistaken by a transfer of the induction cookware. Such an act may include picking up the induction cookware from the first cooking zone and subsequently placing the same induction cookware back on the first cooking zone. This act may be relevant for stirring of food items present in the cookware or removal of food items in the cookware, such as drainage of liquid contained in the induction cookware. Being able to distinguish between the two acts is advantageous in that the cooking process is not unnecessarily disrupted by a user lifting up the induction cookware and placing it back on the same cooking zone.

According to an embodiment, said induction cooking system comprises an external electronic device.

By an external electronic device is understood any kind of electronic device capable of controlling, interacting with, and/or monitoring the induction cooking system. The electronic device is external in the sense that it is not directly involved in a cooking process in the same way that an induction hob and an induction cookware are. Examples of such external electronic devices include handheld electronic devices such as smartphones, smartwatches, tablets, or laptops.

According to an embodiment, steps of the above described method is carried out using a data processing arrangement of said induction cooking system.

By a data processing arrangement is understood one or more data processing units. The data processing unit may be a discrete data processing unit, however the data processing arrangement may also be a distributed data processing system.

According to an embodiment, at least a part of said data processing arrangement is arranged in said induction cookware.

At least a part of the data processing arrangement may be arranged in the induction cookware, for example arranged as a data processing unit in the induction cookware. As an example, the data processing unit may be arranged in a handle of the induction cookware.

Another aspect of the present invention relates to an induction cooking system comprising:
one or more induction hobs comprising a plurality of cooking zones including at least a first cooking zone and a second cooking zone;
an induction cookware comprising one or more sensors, including at least a temperature sensor, and a transmitter for electronic data communication;
an input interface for assigning cooking settings; and
at least one receiver for electronic data communication, said at least one receiver being arranged in one induction hob of said one or more induction hobs;
wherein said transmitter and said receiver are arranged to establish data communication between said induction cookware and said one induction hob; and
wherein said induction cooking system is configured to assign a cooking setting to said first cooking zone, and wherein said induction cooking system is further configured to automatically assign a corresponding cooking setting to said second cooking zone following a transferring of said induction cookware from said first cooking zone to said second cooking zone, wherein said induction cooking system is configured to automatically detect said transferring using sensor input provided by said one or more sensors of said induction cookware.

Thereby is provided an advantageous induction cooking system capable of automatically assignment of corresponding cooking sections following a transfer of an induction cookware from a first cooking zone to a second cooking zone. The induction cooking system is advantageous as it facilitates the carrying out of the method of operating an induction cooking system as described above. Thus, any advantages described in relation to the abovementioned method similarly applies to the induction cooking system.

The receiver may be arranged in an induction hob. In situations where the induction cooking system comprises more than one induction hob, there may be a corresponding plurality of receivers; one receiver per induction hob. The receiver (or receivers) may form part of a wireless communication module, whereby the electronic data communication between induction cookware and induction hob(s) becomes wireless. The wireless communication module may further comprise a transmitter, thereby facilitating two-way wireless data communication with the induction cookware.

According to an embodiment, said induction cooking system comprises a plurality of induction hobs and wherein said plurality of cooking zones are distributed among said plurality of induction hobs.

The induction cooking system may comprise a plurality of induction hobs, such as a first induction hob and a second induction hob. The plurality of cooking zones may be distributed among the plurality of induction hobs, such as that the first cooking zone is arranged on the first induction hob and the second cooking zone is arranged on the second induction hob. Increasing the number of induction hobs is advantageous in that more cooking procedures can be undertaken simultaneously. Furthermore, the present induction cooking system is particularly advantageous when a plurality of induction hobs is present as users of such multi-hob systems will more likely transfer cookware between induction hobs.

According to an embodiment, said induction cooking system comprises a plurality of induction cookware.

The induction cooking system may comprise a plurality of induction cookware such as a first induction cookware and a second cookware, and still be able to facilitate automatic assignment of corresponding cooking settings to such a plurality of induction cookware. Increasing the number of induction cookware is advantageous in that more cooking procedures can be undertaken simultaneously. Furthermore, the present induction cooking system is particularly advantageous when a plurality of cookware are present as users of such multi-cookware systems will more likely transfer cookware between cooking zones.

According to an embodiment, said first cooking zone and said second cooking zone are different with respect to maximal inductive power and/or with respect to maximal inductive power density.

The first cooking zone and the second cooking zone may be different cooking zones in the sense that they are rated at different maximum power. That is, one of the two cooking zones is configured to supply more inductive power than the other at highest power settings. This difference in power between cooking zones is typical of many induction hobs, and for example an induction hob having four cooking zones may have two cooking zones that is rated at a maximum power of 1600 Watts (1850 Watts with booster setting) and two other cooking zones rated at a maximum power of 2100 Watts (3000 Watts with booster setting). This clearly demonstrates that the already pre-configured power steps of an induction hob (typically power steps 1-9 and booster setting “P”) does not translate into the same power output for the different cooking zones. Thus, a user of such an induction hob would have to compensate for this power inequality when transferring a cookware from a “low-power” cooking zone to a “high-power” cooking zone if the cooking conditions in the cookware is to be maintained after the transfer. By inductive power density is understood inductive power per area, such as per area of a cooking zone. For example, two cooking zones may be of equal size (e.g., same diameter) but have different maximally inductive power ratings leading to the two cooking zones having different maximally inductive power densities. Oppositely, the two cooking zones may have the same maximal power ratings but be of different sizes also leading to two different power densities.

According to an embodiment, said first cooking zone and said second cooking zone are different with respect to size.

The first cooking zone and the second cooking zone may differ with respect to size. For example, a diameter of the first or second cooking zone may be greater than the second cooking zone

According to an embodiment, said one or more induction hobs comprises a plurality of pre-defined cooking zones.

The one or more induction hobs may comprise a plurality of pre-defined cooking zones. That is, the plurality of cooking zones are clearly discernible from one another and may e.g., be indicated by corresponding visually marking on the induction hobs. Thereby, a user of the induction cooking system may easily recognize where to place the induction cookware on the induction hobs.

According to an embodiment, said one or more induction hobs comprises one or more free induction hobs.

By a free induction hob is understood a hob comprising a plurality of induction coils underneath, where each of the induction coils is controllable individually and in combination. An induction cookware placed on the hob defines with its base a cooking zone. Those induction coils which are at least partly covered by the cooking zone are controlled for the common heating of the induction cookware.

Such free induction hobs may comprise a plurality of induction coils, such as more than four induction coils, such as more than ten induction coils, for example 40 induction coils. Therefore, a cooking zone may be defined as an area (or section) of an induction hob comprising at least one induction coil arranged for the purpose of cooking using an induction cookware placed on the cooking zone.

According to an embodiment, said induction cookware comprises a wire loop for detecting changes in a magnetic field.

The wire loop may be a dedicated wire loop or it may form part of the temperature sensor.

According to an embodiment, said induction cooking system comprises an external electronic device.

According to an embodiment of the invention, said induction cooking system is arranged to carry out the method according to any of the preceding provisions. Thus, any advantage described in relation to carrying out the method may also apply for the induction cooking system.

According to an embodiment of the invention, said induction cooking system comprises any system related feature described in relation to the method according to any of the preceding provisions. Thus, any advantage described in relation to such features may also apply for the induction cooking system.

Another aspect of the present invention relates to an induction cooking zone configured to automatically switch between cooking settings upon detecting a switch of induction cookware positioned on said cooking zone.

A user of the induction cooking zone may remove first induction cookware present on the induction cooking zone and replace the first induction cookware by a second induction cookware in which a different cooking process is to occur. The different cooking processes of the first and second induction cookware implies a switch in cooking settings as the cookware is switched. The induction cooking zone is configured to automatically perform such a switch between cooking settings based on a detection of cookware switch. Thereby is provided an advantageous induction cooking zone. The automatic switching between cooking settings is advantageous in that a seamless cooking experience may be achieved.

According to an embodiment, said induction cooking zone forms part of an induction cooking system.

The induction cooking zone may form part of an induction cooking system as described in any of the above. In that sense the induction cooking zone may be one of a plurality of cooking zones of an induction cooking system.

According to an embodiment of the invention, the cooking zone is implemented according to any of the previously disclosed provisions. That is, the induction cooking zone may be an induction cooking zone of an induction cooking system according to any of the previously disclosed provisions.

According to an embodiment, said cooking settings dictate that inductive power is to be supplied to cookware positioned on said cooking zone.

A cooking setting may thus be different from a setting implying that no power is applied to a cookware, such as a pause setting or a zero setting.

According to an embodiment, said cooking zone is associated with a plurality of induction coils of an induction hob.

The cooking zone may be associated with a plurality of induction coils arranged underneath the cooking zone of an induction hob, which in this embodiment may be referred to as a free induction hob.

According to an embodiment of the invention, the cooking zone may operate in accordance with the method according to any of the previously disclosed provisions.

### THE DRAWINGS

Various embodiments of the invention will in the following be described with reference to the drawings where

FIGS. 1a-1b illustrate cooking systems according to embodiments of the invention,

FIGS. 2a-2b illustrate a cooking system and operation thereof according to an embodiment of the invention,

FIG. 3 illustrates a transfer of an induction cookware according to an embodiment of the invention,

FIG. 4 illustrates a transfer of an induction cookware according to another embodiment of the invention,

FIGS. 5a-5b illustrate assigning of a cooking setting and a corresponding cooking setting according to an embodiment of the invention,

FIG. 6 illustrates a method of operating an induction cooking system according to an embodiment of the invention,

FIG. 7 illustrates an induction cooking system according to another embodiment of the invention,

FIG. 8 illustrates a see-through view of an induction cookware for use in an induction cooking system according to embodiments of the invention,

FIG. 9 illustrates a side-view of an induction cookware for use in an induction cooking system according to embodiments of the invention, and

FIGS. 10a-b illustrate an induction cooking zone according to an embodiment of the invention.

### DETAILED DESCRIPTION

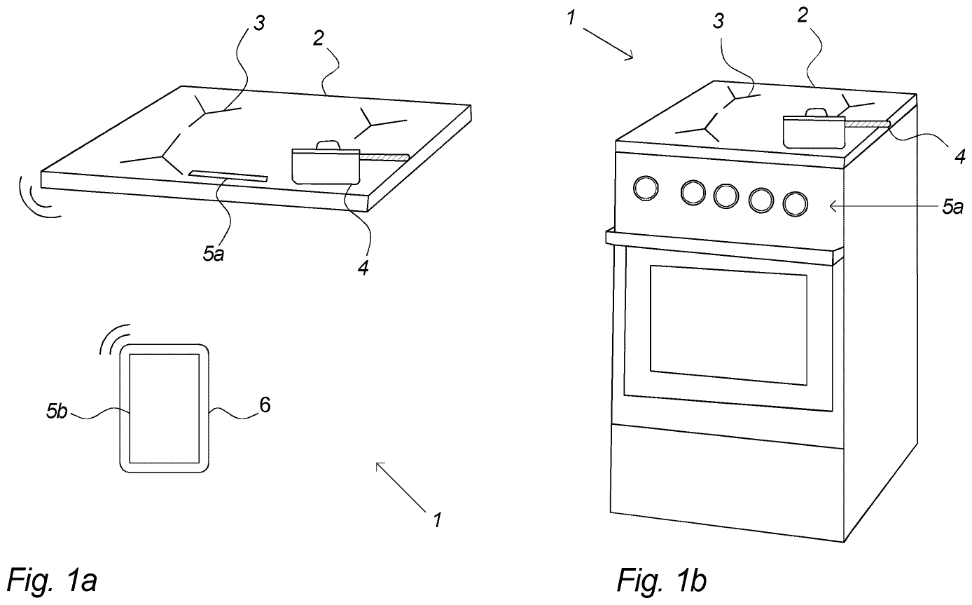

FIG. 1a and FIG. 1b illustrate induction cooking systems 1 according to embodiments of the present invention. The induction cooking system 1 seen in FIG. 1a comprises an induction hob 2 having four cooking zones 3 and a user interface 5a, an induction cookware 4 in the form of a saucepan having a lid, and an electronic device 6 in the form of an electronic tablet. In the following the terms induction cookware and cookware may be used interchangeably. The electronic device 6 comprises a graphical user interface 5b for adjusting cooking settings, and the electronic device 6 is wirelessly connected with the induction hob 2 such that selected cooking settings can be conveyed to the induction hob 2. The induction cooking system is configured such that the induction hob 2 delivers inductive power to the cookware 4 through the cooking zone 3 on which the cookware 4 is placed. As seen, the induction cooking system 1 of FIG. 1 is a free-standing system which may be incorporated into a kitchen tabletop.

FIG. 1b illustrates a similar induction cooking system 1 as seen in FIG. 1a, which comprises an induction hob 2 having a plurality of cooking zones 3, and an induction cookware 4. The induction cooking system 1 of FIG. 1b, however, is integrated into a stove which also comprises an oven. Both induction cooking systems 1 comprises one or more user interfaces enabling a user to adjust cooking settings for respective cooking zones 3 of the induction hob 2. The induction cooking system 1 of FIG. 1a comprises a touch sensitive user interface 5a integrated into the induction hob 2, and a user interface 5b facilitated by the electronic device 6 by use of a digital screen thereof. The induction cooking system 1 of FIG. 1b also comprises a user interface 5a in the form of rotary knobs or dials.

It should be noted that although the embodiments of FIG. 1a and 1b illustrates specific user interfaces and system components it should be understood that other configurations are conceivable according to the claims. For example, the electronic device 6 and touch-based user interface 5a of the induction hob 2 shown in FIG. 1a may also be used in conjunction with the induction cooking system of FIG. 1b, and the user interface 5a of FIG. 1b may be used in the induction cooking system of FIG. 1a.

As seen in FIGS. 1a and 1b, the cooking zones 3 are indicated by “Y”-like shapes/markings, however other types of markings are also conceivable, such as circular markings, and according to other embodiments there may be no zone marking present at all. Avoiding zone markings may serve an aesthetic purpose or actually reflect that there are no predefined zones as such, which is the case of a free induction hob.

The induction cookware 4 as seen in either FIG. 1a or FIG. 1b can be used for cooking of food items stored inside the cookware. In order to do so, a user assigns a cooking setting to the cooking zone 3 on which the cookware 4 is placed. This assignment of a cooking setting can be made by use of a user interface 5.

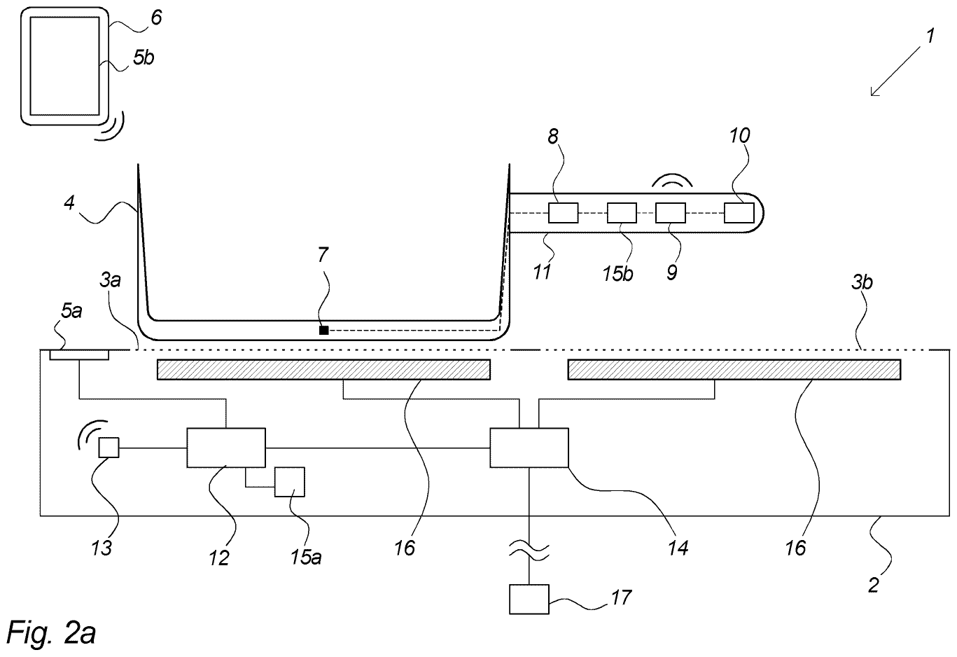

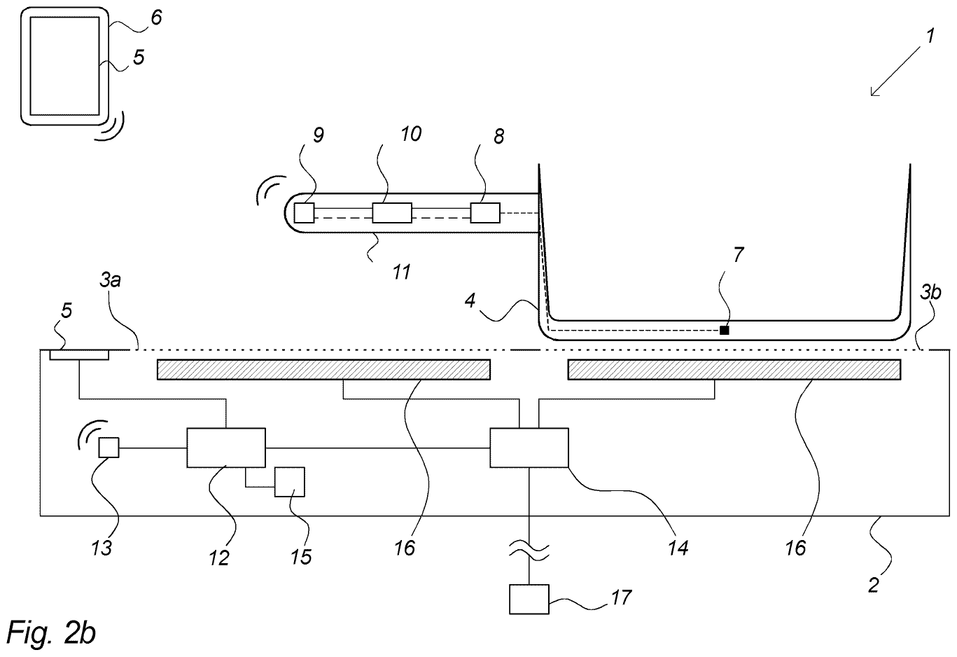

FIGS. 2a-2b illustrate an induction cooking system 1 according to an embodiment of the present invention.

The induction cooking system 1 shown in FIG. 2a may be a free-standing system (see FIG. 1a) or may form part of a stove (see FIG. 1b). The induction cooking system 1 comprises an induction hob 2 and an induction cookware 4. As seen in the figure, the induction cookware 4 is positioned on the induction hob 2 over a first cooking zone 3a. The first cooking zone 3a is seen arranged above an induction coil 16 of the induction hob 2. As also seen in FIG. 2a, a second cooking zone 3b is also present. The second cooking zone 3b is also arranged above an induction coil 16 of the induction hob 2. The induction coils are electrically powered by a power supply 14 of the induction hob 2. Each of the induction coils is configured to transmit inductive power to an induction cookware 4 positioned on a cooking zone over the respective induction coil by means of induction. In the embodiment shown in FIG. 2a, there is only one induction coil per cooking zone, however, according to other embodiments of the invention, a cooking zone may be associated with a plurality of induction coils. A cooking zone associated with a plurality of induction coils may be configured in such a way that the induction coils are positioned around a common center point but the individual coils vary in size, thereby achieving a cooking zone adaptable to various sizes of cookware. The greater the size of the cookware being used the greater the number of induction coils being used for the cooking zone. Furthermore, other induction hobs with cooking zones that are each associated with a plurality of induction coils are also known as “free induction hob”. The cooking zones of such free induction hobs are adaptable, and the plurality of induction coils thereof are not predefined meaning that the specific plurality of induction coils making up the cooking zone depends on where the cookware is placed on the induction hob. Furthermore, FIG. 2a only shows two cooking zones; a first cooking zone 3a and a second cooking zone 3b, however, it should be noted that the induction hob 2 illustrated in FIG. 2a may also represent a side-view of any of the induction hobs 2 shown in FIG. 1a or 1b. Therefore, the induction hob 2 shown in FIG. 2a may comprise additional cooking zones 3 not shown in the figure. What is important for the present understanding is that the induction hob 2 comprises at least two cooking zones; a first cooking zone 3a and a second cooking zone 3b.

In addition, to the induction coils 16 and the power supply 14, the induction hob 2 comprises a user interface 5a. The user interface 5a is of the type seen in FIG. 1a. i.e., a touch-sensitive user interface where a user can assign a cooking setting, in this case a power level selected from power levels one through nine and a booster power level. Such a booster power level may also commonly be referred to as “P” or “Booster” setting. Furthermore, the induction hob 2 comprises a controller for controlling the power emitted by the power supply 14 to the induction coils 16. The controller 12 is communicatively coupled with a digital memory 15a. The induction hob 2 receives electric power from an external power supply 17, such as a mains connection. The induction hob 2 also comprises a wireless communication module 13 configured to wirelessly communicate data with other system components including the induction cookware 4 and an electronic device 6. The electronic device 6 of the system as seen in FIG. 2a is in the form of an electronic tablet, however, other kinds of electronic devices may also be used according to other embodiments, such as a smartphone, a smartwatch, or a laptop. The electronic device 6 comprises a user interface 5b facilitated by an electronic display of the device.

The induction cookware 4 shown in FIG. 2a is of a similar type as the induction cookware seen in FIGS. 1a and 1b, albeit the lid has been removed in FIG. 2a. It should be noted that other types of induction cookware are conceivable according to other embodiments. The induction cookware 4 of FIG. 2a comprises a temperature sensor 7 of the type RTD (Resistance Temperature Detector), however, other types of temperature sensors are also usable according to other embodiments of the invention, such as thermocouples and thermistors. The temperature sensor 7 is used to measure temperatures of the induction cookware, and in particular temperatures relevant for the cooking of food items in the cookware. As seen, the temperature sensor 7 is positioned at a central position in the bottom part of the induction cookware, as this is a position close to most food items during cooking, and therefore the temperatures measured by the sensor are to a large extent representative of actual cooking temperatures. In addition to measuring cooking temperatures, the temperature sensor 7 is arranged with electric wires which together forms a wire loop. During cooking using induction, currents are induced in this wire loop, and changes in the alternating magnetic field generated by induction coil 16 beneath the induction cookware 4 are detectable using the wire loop. It should be noted that the abovementioned wire loop should not be construed in such a way that the wire loop must comprise dedicated turn(s) of wires. As a matter of fact, the wire loop may exist purely as a consequence of the particular wiring used in order for the correct functioning of the temperature sensor. This, however, does not exclude the possibility of having a dedicated wire loop as a sensor for establishing measurements relating to magnetic field, and FIG. 8 describes an embodiment of the invention where indeed such a wire loop sensor is used. The significance of the establishing of measurements relating to magnetic field will be explained in greater detail below.

The induction cookware 4 further comprises a data processing unit 8 communicatively coupled with the temperature sensor 7, such that temperature readings can be provided in the data processing unit. The data processing unit 8 facilitates among others a transmission of the temperature readings through a transmitter 9 of the induction cookware 4. The electronics of the induction cookware, i.e., temperature sensor 7, data processing unit 8, and transmitter 9 are powered by a power supply 10. The power supply 10 in this embodiment is a battery which is placed in a handle 11 of the induction cookware 4 together with the data processing unit 8 and the transmitter 9. In the present embodiment, the induction cookware also comprises a digital memory 15b. As seen in the figure, dashed lines are provided between the temperature sensor 7, the data processing unit 8, the digital memory 15b, the transmitter 9 and the battery 10, indicating that these components are electrically coupled, powered by the battery 10 and data flow may occur between temperature sensor 7, data processing unit 8, the digital memory 15b and transmitter 9. It should be noted that in the present embodiment, the data processing unit 8, digital memory 15b, transmitter 9 and battery 10 are shown as discrete components that are electronically coupled to one another, however, according to other embodiments of the invention some of these components may be integrated in a common component (e.g., data processing unit and digital memory 15b combined in a single component), and the components may also be arranged on a common printed circuit board (PCB). In other embodiments of the invention, the power supply may be a mains connection or may be an energy harvesting unit arranged to harvest electric energy from the alternating magnetic field generated by an induction coil 16.

As is evident from FIG. 2a, the induction cooking system 1 comprises multiple units; an induction hob 2, an induction cookware 4 and an electronic device 6. The electronic device 6 is a discrete device which is external to the induction hob 2 and the induction cookware 4. Accordingly, throughout the following, the electronic device 6 may also be referred to as an external electronic device. In this embodiment, all units are interconnected and capable of transmitting data between each other. Thus, a user of the induction cooking system 1 can assign cooking settings to the induction cookware 4 placed on the first cooking zone 3a from the user interface 5a of the induction hob or from the user interface 5b of the electronic device 6, for example using a graphical user interface of the electronic device. Furthermore, the induction cookware 4 can transmit temperature readings, and measurements relating to the alternating magnetic field generated by the induction coil 16 to the induction hob 2 and/or the electronic device 6. Once the cooking setting is applied to the first cooking zone 3a, the induction cookware 4 will cook the food content present inside it. In this embodiment a user of the system has selected a cooking recipe via the user interface 5b of the electronic device 6. The cooking recipe defines a sequence of cooking temperatures over time.

As is typical for cooking, the user of the system may come to a point in the overall cooking process where the induction cookware 4 is moved to another cooking zone 3, for example the second cooking zone 3b. A need of such a shift in cookware placement may arise for many reasons, one being that a user will typically only focus on one piece of cookware at a time, and once the food content of that cookware is left in a state in which for example a simmering process can occur, the cookware is moved to simmer on another cooking zone 3 leaving room for another piece of cookware on the users most favored cooking zone.

FIG. 2b illustrates the same induction cooking system 1 as seen in FIG. 2a, however the induction cookware 4 has been transferred from the first cooking zone 3a to the second cooking zone 3b. Although the first cooking zone 3a and the second cooking zone 3b, with their respective induction coils 16, appears identical, this is not necessarily the case. For the purpose of understanding, the two cooking zones are different with respect to their capabilities of transferring inductive power, and more specifically, the second cooking zone 3b is configured to deliver a higher maximum inductive power than the first cooking zone 3a. A skilled reader will immediately appreciate that this difference has significant implications on the control of a cooking process. A new cooking setting has to be applied to the second cooking zone 3b, however, due to the different power ratings of the two cooking zones, the cooking setting for the second cooking zone may differ from the cooking setting previously used when the cookware was placed on the first cooking zone. This difference may easily be understood using the typical cooking settings (one through nine) on a typical cooking hob. The highest setting (nine) would correspond to different power levels, and therefore a setting of level four on a first cooking zone may correspond to a setting of level three on the second cooking zone. In practice there may however not be such a direct correspondence between the pre-configured power settings on a cooking hob.

The induction cooking system 1 according to this embodiment of the invention is capable of automatically applying a corresponding setting to the second cooking zone 3b. This means that the cooking recipe initiated by the user once the induction cookware 4 was placed on the first cooking zone 3a (see FIG. 2a), can continue its progression with the induction cookware 4 being positioned on the second cooking zone 3b. For this to occur automatically it is crucial that the induction cooking system 1 is always aware of which cooking zones a cookware is placed on, and not only that, but especially also which specific piece of cookware is placed on what cooking zone. In this embodiment, the detection of cookware placement is made using measurements of the alternating magnetic field, however, other methods may be used according to other embodiments, such as by use of a camera system. In the present embodiment, the controller 12 of the induction hob 2 is always aware of the electric power supplied to the induction coils 16. Thereby, the controller 12 is always aware of the characteristics of the magnetic field generated by the induction coils. In this embodiment the controller 12 ensures that distinct modulations are applied to the electric signals feeding into the induction coils 16. Thereby, each of the induction coils generate a magnetic field having a unique signature provided by the modulation. Thus, the first cooking zone 3a may be associated with an alternating magnetic field having a modulation different from the modulation of the alternating magnetic field associated with the second cooking zone 3b. The induction cookware 4 is configured to detect the alternating magnetic field and thereby also infer the characteristics of the alternating magnetic field. Thus, the induction cookware 4 can infer unique signature of the cooking zone in which it is positioned, however the induction cookware 4 itself cannot determine where on the induction hob 2 it is placed. For this to happen the induction cookware 4 would need to know the unique signatures provided by the cooking zones 3 of the induction hob 2. However, the induction cookware 4 is configured to transmit measurements relating to the experienced alternating magnetic field to the induction hob 2 by establishing a data communication link between the transmitter 9 and the wireless communication module 13. The controller 12 receives the data transmitted from the induction cookware 4 and using its knowledge of the applied modulations/signatures, the controller can deduce that the cookware has been transferred from (in this embodiment) the first cooking zone 3a to the second cooking zone. The controller 12 already knows what cooking setting was previously applied to the first cooking zone 3a, and therefore knows what corresponding cooking setting is required for the second cooking zone 3b for the cooking recipe to progress as intended.

Alternatively, or additionally, to the above-described use of unique signatures encoded in the alternating magnetic field generated by the cooking zone, another detection mechanism may be employed according to embodiments of the invention. This detection mechanism is based on the fact that the cooking hob may already know whether an induction cookware is placed on one of its cooking zones or not, as well as the timing involved with detection of an alternating magnetic field. When an induction cookware is placed/or removed from a cooking zone of an induction hob, the induction hob may automatically establish a point in time at which the placement/removal took place. Likewise, when the cookware is placed on (or removed from) a cooking zone the cookware may also establish a point in time in which an alternating magnetic field is measured (or not). By correlating these points in time, the induction cooking system may deduce that a transfer of cookware has been made.

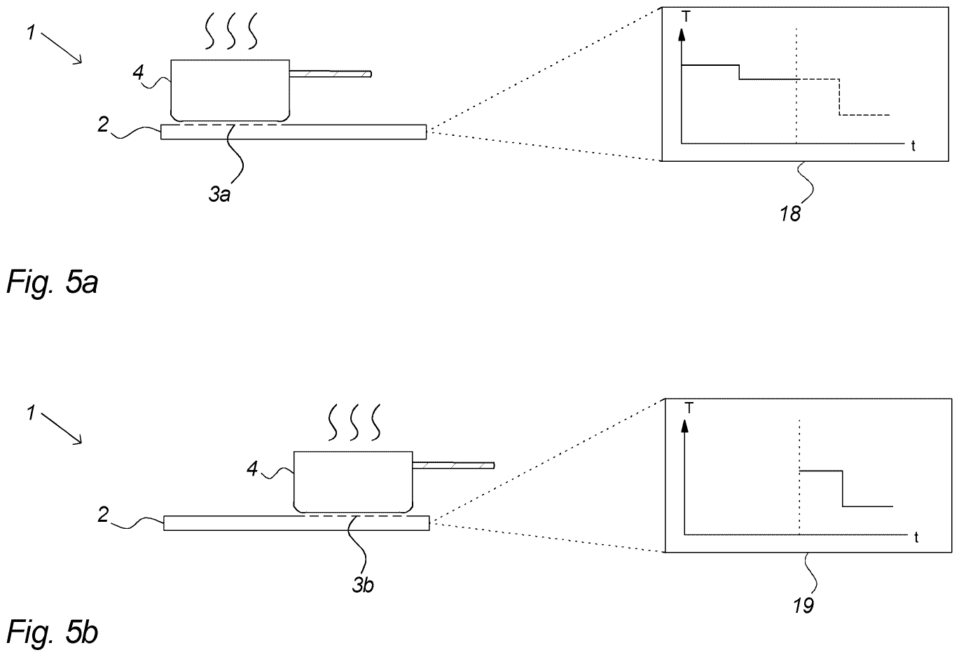

Since the cooking setting assigned to the first cooking zone 3a is a cooking recipe, the corresponding cooking setting automatically assigned to the second cooking zone 3b is also a cooking recipe, and more specifically the unelapsed (in time) part of the cooking recipe initiated for the first cooking zone 3a. This is explained in greater detail in FIG. 5.

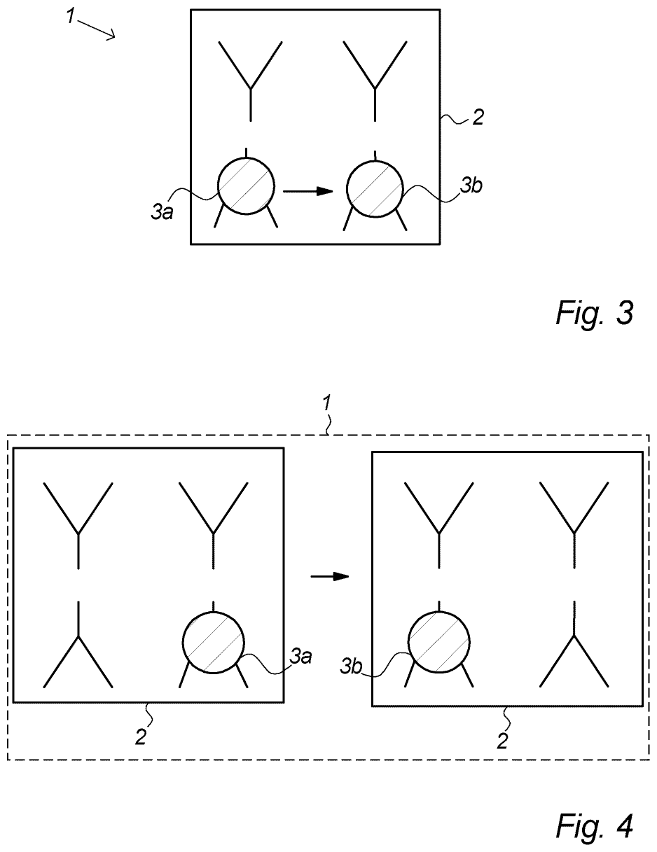

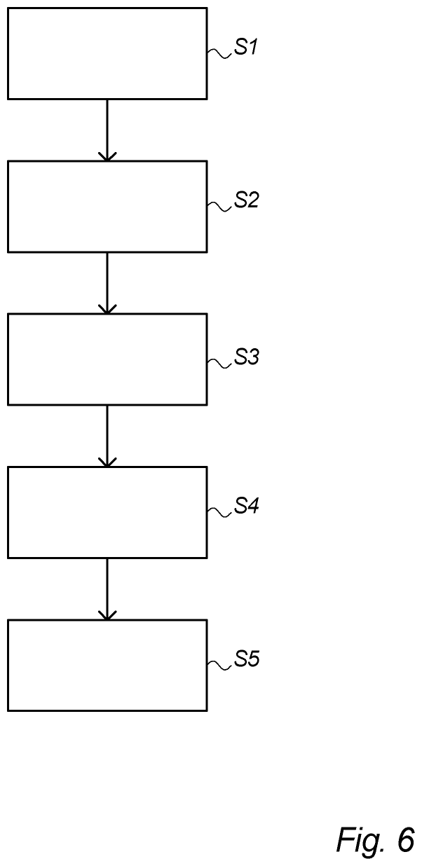

FIG. 3 illustrates a transfer of an induction cookware according to an embodiment of the invention. As seen in FIG. 3, the induction cooking system 1 comprises a single induction hob 2 comprising a plurality of cooking zones (specifically four cooking zones), including a first cooking zone 3a and a second cooking zone. A user of the induction cooking system 1 has initiated a cooking process with the induction cookware 1 positioned in the first cooking zone 3a, and during the cooking process the user of the system transfers the induction cookware to a second cooking zone 3b present on the same induction hob 2. The induction cooking system 1 shown in FIG. 3 is configured to automatically assign a corresponding cooking setting to the second cooking zone 3b, for example in the way explained in relation to FIGS. 2a-2b, or according to the general method explained in relation to FIG. 6.

FIG. 4 illustrates a transfer of an induction cookware according to another embodiment of the invention. As seen in FIG. 4, the induction cooking system 1 comprises a plurality of induction hobs 2 (specifically two induction hobs), which together comprises a plurality of cooking zones 3 (specifically eight cooking zones) including a first cooking zone 3a and a second cooking zone 3b. What should be immediately noted is that the first cooking zone 3a and the second cooking zone 3b are arranged on respective induction hobs 2. In this embodiment of the invention, the controller 12 (see FIGS. 2a-2b) of each induction hob 2 is configured to communicate mutually with one another via their respective wireless communication modules 13 (see also FIGS. 2a-2b). Thereby, the system may detect a removal of an induction cookware from one induction hob 2 and a placement of that cookware on another induction hob 2 of the system. The induction cooking system 1 shown in FIG. 4 is configured to automatically assign a corresponding cooking setting to the second cooking zone 3b, for example in the way explained in relation to FIGS. 2a-2b, or according to the general method explained in relation to FIG. 6. In an alternative embodiment, the two induction hobs 2 may not need to communicate mutually with one another as the information needed for the detection of the transfer may be stored in a digital memory of the cookware (see for example digital memory 15b in FIG. 2a).

FIGS. 5a-5b illustrate the assigning of a cooking setting and a corresponding cooking setting according to an embodiment of the invention. The induction cooking system 1 as seen in FIG. 5a may be the same induction cooking system as seen in FIG. 2a. In FIG. 5a an induction cookware 4 is placed on a first cooking zone 3a of an induction hob 2. A user of the system has assigned a cooking setting 18 to the first cooking zone 3a. This is for example done using a user interface 5b of an electronic device 6 (see FIG. 2a). The cooking setting 18 seen in FIG. 5a is a cooking recipe. The cooking recipe is illustrated by a graph showing cooking temperature (T) as a function of time (t). As seen the cooking recipe comprises maintaining the induction cookware at three different cooking temperatures for three different time periods. It should be noted that the illustrated graph is only used for understanding of a cooking setting and is not necessarily representative of an actual cooking recipe. As seen in FIG. 5a, the graph is divided into two parts by a vertical dashed line. The part of the curve to the left of the vertical dashed line (i.e., the solid curve) represents the part of the cooking recipe which has elapsed at the point in time where the induction cookware 4 is transferred away from the first cooking zone 3a. Accordingly, the part of the curve to the right of the vertical dashed line (i.e., the dashed curve) represents the part of the cooking recipe which is unelapsed. FIG. 5b illustrates the same induction cooking system 1 as seen in FIG. 5a, however the induction cookware 4 has been moved to a second cooking zone 3b. The induction cooking system 1 has detected this transfer, using e.g., the method described in relation to FIGS. 2a-2b, and automatically applied a corresponding cooking setting 19 to the second cooking zone 3b. In this case the corresponding cooking setting 19 represent the unelapsed part of the curve shown in FIG. 5a. As seen in FIGS. 5a-5b the transfer of the cookware by a user of the cooking system has not affected the progression of the cooking process initiated when assigning the cooking setting to the first cooking zone 3a.

In the embodiments described above, the cooking setting 18 and corresponding cooking setting 19 have been cooking recipes, however, a cooking recipe is only one kind of cooking setting, and according to other embodiments of the invention the cooking setting may be a cooking temperature, an inductive power supplied by one or more induction coils, a state of a cookware (for example a resting/cooling state where no inductive power is to be supplied), and a power density amongst others. The skilled person would readily appreciate that the cooking settings referred to in any of the previously described embodiments may also be any of these kinds of cooking settings.

FIG. 6 illustrates a method of operating an induction cooking system according to an embodiment of the invention. The method comprises method steps S1-S5.

In a first step S1, an induction cooking system 1 is provided. The induction cooking system 1 comprises one or more induction hobs 2 which together comprise a plurality of cooking zones 3. As such, the induction cooking system 1 may be any induction cooking systems 1 as illustrated in the preceding figures.

In a second step S2, an induction cookware 4 is placed on a first cooking zone 3a of the plurality of cooking zones 3. The induction cookware 4 may be any induction cookware as illustrated in the preceding figures.

In a third step S3, a cooking setting 18 is assigned to the first cooking zone 3a. The cooking setting 18 may be a cooking setting as described in relation to FIG. 5a, however the cooking setting may also be any of a target temperature of the induction cookware, present power supplied to the induction cookware, remaining time of cooking process or remaining time of a sub-step of the cooking process, time-dependent power setting (a specific amount of inductive power to be supplied for a certain amount of time), a time-dependent temperature setting (a specific target temperature of the induction cookware to be maintained for a certain amount of time), or a state of the cookware.

In a fourth step S4, a user of the induction cooking system 1 transfers the induction cookware 4 from the first cooking zone 3a to a second cooking zone 3b. As is clear from the preceding description, the second cooking zone 3b may be disposed on the same induction hob 2 as the first cooking zone 3a, or it may be disposed on another induction hob 2, whereby the transferring of the cookware 4 entails transferring from a first induction hob to a second induction hob.

In a fifth step S5, a corresponding cooking setting 19 is assigned to the second cooking zone 3b. The corresponding cooking setting 19 may be a corresponding cooking setting as described in relation to FIG. 5b, however the corresponding cooking setting may also be any of a target temperature of the induction cookware, present power supplied to the induction cookware, remaining time of cooking process or remaining time of a sub-step of the cooking process, time-dependent power setting (a specific amount of inductive power to be supplied for a certain amount of time), a time-dependent temperature setting (a specific target temperature of the induction cookware to be maintained for a certain amount of time), or a state of the cookware.

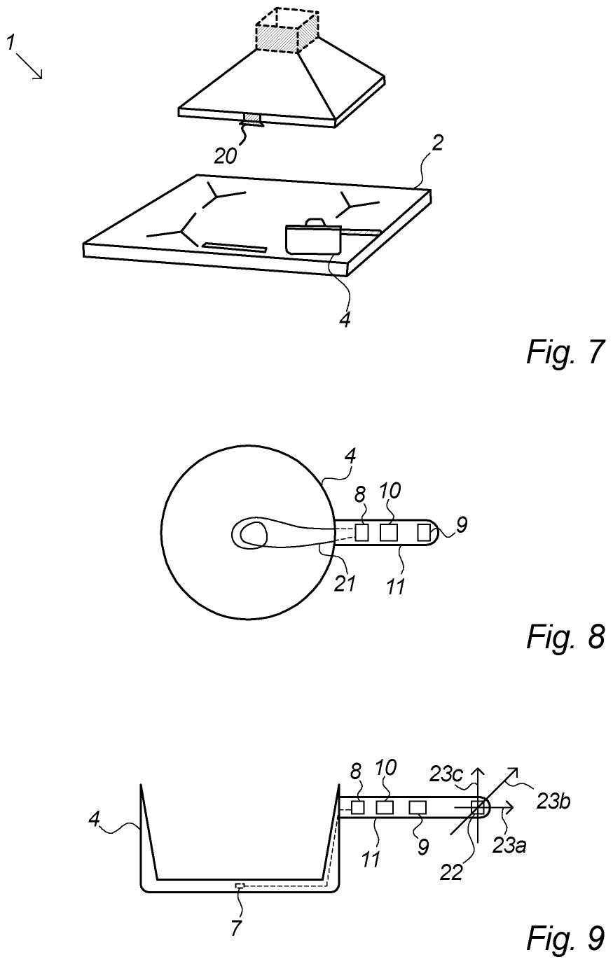

FIG. 7 illustrates an induction cooking system according to another embodiment of the invention. In this embodiment, the position of the induction cookware 4 is continuously tracked by use of a camera system 10. Using computer vision (object detection), the camera system 20 can not only identify the presence of a cookware on a cooking zone 3 of the system, the camera system 20 can also establish an identity of the specific cookware, and thereby a piece of cookware 4 can be distinguished from another piece of cookware. Distinguishing one cookware from another may involve identifying the contents of the different pieces of cookware. In the induction cooking system 1 as seen in FIG. 7, the camera system 20 is communicatively coupled to the controller 12 of the induction hob (see FIG. 2a), and/or an electronic device 6 (see for example also FIG. 2a). Data processing units of the induction cooking system 1 (present in or distributed across any of the system components; camera system 20, induction hob 2, induction cookware 4 and electronic device) may analyse images obtained by the camera system using any known method of object detection and thereby infer which cookware is placed on which cooking zone of the induction cooking system. As this is continuously established, any transfer of a cookware 4 made by a user of the system will be tracked and corresponding cooking settings will be applied to the cooking zone to which the cookware is transferred. It should be noted that FIG. 7 only shows an induction cooking system comprising a single induction hob 2 and a single piece of cookware 4, however, the image-based transfer detection shown in FIG. 7 can equally be used for systems comprising multiple pieces of cookware 4 and/or multiple induction hobs 2. In cases of multiple induction hobs 2, the camera system 20 may comprise several camera units associated with corresponding induction hobs 2. The induction cooking system according to this embodiment, or a system comprising multiple camera units, may be configured to execute the method according to FIG. 6.

FIG. 8 illustrates a see-through view of an induction cookware 4 for use in an induction cooking system 1 according to any of the previously described embodiments. As seen in FIG. 8, the induction cookware 4 comprises a wire loop sensor 21 which is built-in in a base part of the induction cookware 4. The cookware 4 further comprises a data processing unit 8, a power supply 10 in the form of a battery, and a transmitter 9. Although not seen in the figure, the induction cookware 4 may further comprise a temperature sensor, and yet in another embodiment, the wire loop sensor 21 is realized through wiring of a temperature sensor (see also description in relation to FIGS. 2a and 2b). The wire loop sensor 21 can detect the alternating magnetic field generated by an induction coil 16 of an induction hob as also explained in relation to FIGS. 2a-2b.

FIG. 9 illustrates a side-view of an induction cookware 4 for use in an induction cooking system 1 according to any of the previously described embodiments. The induction cookware comprises an accelerometer 22 in the form of a three-axis accelerometer. Thus, the accelerometer 22 is capable of detecting accelerations of the induction cookware along three orthogonal axis 23a-23c. The induction cookware 4 further comprises temperature sensor, a data processing unit 8, a power supply 10 in the form of a battery, and a transmitter 9. The accelerometer 22 is further used to confirm that a transfer of the cookware 4 has occurred as such a transfer/movement is detectable using the accelerometer 22. Thus, by use of the accelerometer a more robust way of detecting cookware transfer is realized.

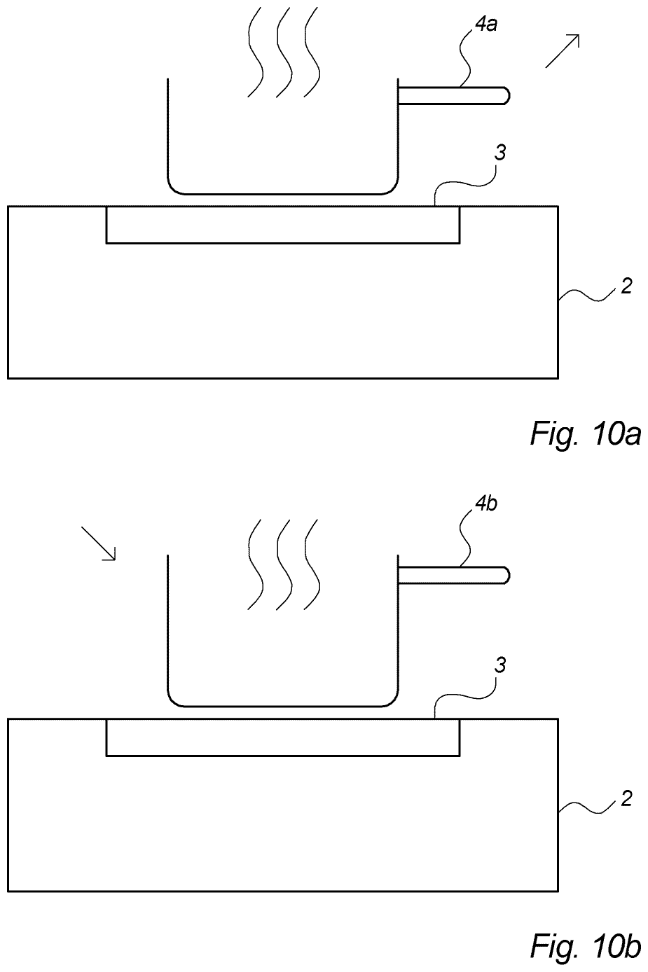

FIGS. 10a-b illustrate an induction cooking zone 3 according to an embodiment of the invention. The cooking zone 3 is arranged in an induction hob 2 which may comprise any of the system components as seen in FIG. 2a. As seen in FIG. 10a, a first induction cookware 4a is positioned on top of the cooking zone 3. A cooking process is occurring in the first induction cookware 4a, which cooking process is according to a first cooking setting applied to the induction cooking zone 3. The cooking setting may be any type of cooking setting as described in the above. As indicated by the arrow in FIG. 10a, the first induction cookware is transferred away from the cooking zone. This transfer may be a transfer away from the induction hob due to the cooking process being finished, or a transfer to another cooking zone as exemplified in the above. FIG. 10b illustrates the same induction cooking zone 3 as seen in FIG. 10a, however FIG. 10b illustrates a later instance in time where a second induction cookware 4b is positioned on top of the cooking zone 3. The arrow in FIG. 10b illustrates that the second induction cookware 4b is placed on the cooking zone 3 after removal of the first induction cookware 4a.

The induction cooking zone 3 shown in FIGS. 10a-b is configured to automatically detect a switch of induction cookware. In this embodiment, the first induction cookware 4a and the second induction cookware 4b are configured to detect the alternating magnetic field generated by induction coil(s) of the induction cooking zone 3, however other detection methods have already been disclosed in the above, and these could also be utilized here. The induction cooking zone 3 shown in the figure is configured to automatically switch between the cooking settings needed for the cooking processes occurring in the first induction cookware 4a and the second induction cookware 4b. This automatic change is performed in response to detecting a switch of the cookware. It should be noted that the cooking settings used for the first induction cookware 4a and the second induction cookware 4b may also be stored in a digital memories 15b of the respective cookware and executed in the respective cookware. Thus, when the first and second cookware are moved, the respective cooking settings may also “move” with the cookware, however, from the viewpoint of the induction cooking zone a switching of cooking setting is performed as a result of the switch of cookware. It should be understood that the invention is not limited to the particular examples described above but may be designed and altered in a multitude of varieties within the scope of the invention as specified in the claims.

### LIST OF REFERENCE SIGNS

1 Induction cooking system
2 Induction hob
3 Cooking zone
3a First cooking zone
3b Second cooking zone
4 Induction cookware
4a First induction cookware
4b Second induction cookware
5a User interface of induction hob
5b User interface of electronic device
6 Electronic device
7 Temperature sensor of induction cookware
8 Data processing unit of induction cookware
9 Transmitter of induction cookware
10 Power supply of induction cookware
11 Handle
12 Controller
13 Wireless communication module
14 Power supply
15a Digital memory of induction hob
15b Digital memory of induction cookware
16 Induction coil
17 External power supply
18 Cooking setting
19 Corresponding cooking setting
20 Camera system
21 Wire loop sensor
22 Accelerometer
23a-c Direction of movements
S1-S5 Method steps

1. A method of operating an induction cooking system comprising:
providing an induction cooking system comprising one or more induction hobs comprising a plurality of cooking zones;
placing an induction cookware on a first cooking zone of the plurality of cooking zones, wherein the induction cookware comprises one or more sensors;
assigning a cooking setting to the first cooking zone;
transferring, by a user of the induction cooking system, the induction cookware to a second cooking zone of the plurality of cooking zones;
automatically detecting, by the induction cooking system, transfer of the induction cookware using sensor input provided by the one or more sensors of the induction cookware; and
automatically assigning a corresponding cooking setting to the second cooking zone.

2. The method according to claim 1, wherein the one or more sensors comprise one or more temperature sensors.

3. The method according to claim 1, wherein the induction cookware comprises a digital memory storing thereon a cookware identifier identifying the induction cookware in the induction cooking system.

4. The method according to claim 3, wherein the method further comprises assigning the cooking setting to the cookware identifier.

5. The method according to claim 3, wherein automatically assigning a corresponding cooking setting to the second cooking zone is performed based on the cookware identifier.

6. The method according to claim 1, wherein automatically detecting the transfer is established based on one or more measurements relating to a magnetic field and/or an electric field generated by the one or more induction hobs, the one or more measurements being provided by the one or more sensors of the induction cookware.

7. The method according to claim 1, wherein automatically detecting the transfer is performed by a data processing arrangement of the induction cooking system, the data processing arrangement correlating measurements provided by the one or more sensors of the induction cookware with a power status of the one or more induction hobs.

8. The method according to claim 1, wherein the one or more sensors comprises a wire loop and/or an accelerometer.

9. (canceled)

10. (canceled)

11. The method according to claim 1, wherein assigning the cooking setting to the first cooking zone is carried out by a user assigning the cooking setting using an input interface of the induction cooking system, wherein the input interface forms part of an external electronic device of the induction cooking system.

12. (canceled)

13. (canceled)

14. The method according to claim 1 claims, wherein assigning the cooking setting to the first cooking zone is carried out automatically by the induction cooking system based on detection of placement of the induction cookware on the first cooking zone.

15. (canceled)

16. The method according to claim 1, wherein the cooking setting comprises one or more of temperature, power, power density and time.

17. (canceled)

18. (canceled)

19. (canceled)

20. The method according to claim 1, wherein the cooking setting is a time-dependent cooking setting comprising a temperature profile.

21. (canceled)

22. The method according to claim 1, the cooking setting is a time-dependent cooking setting, and wherein the corresponding cooking setting comprises an unelapsed part of the cooking setting.

23. (canceled)

24. The method according to claim 1, the cooking setting is a cooking recipe, and wherein the corresponding cooking setting is a corresponding cooking recipe.

25. (canceled)

26. (canceled)

27. The method according to claim 1, the induction cookware is a first induction cookware and wherein the method further comprises placing a second induction cookware on the first cooking zone after the first induction cookware is transferred to the second cooking zone and assigning a new cooking setting to the first cooking zone.

28. (canceled)

29. (canceled)

30. The method according to claim 1, wherein the method is carried out using a data processing arrangement of the induction cooking system.

31. (canceled)

32. An induction cooking system comprising:
one or more induction hobs comprising a plurality of cooking zones including at least a first cooking zone and a second cooking zone;
an induction cookware comprising one or more sensors, including at least a temperature sensor, and a transmitter for electronic data communication;
an input interface for assigning cooking settings; and
at least one receiver for electronic data communication, the at least one receiver being arranged in one induction hob of the one or more induction hobs, wherein:
the transmitter and the at least one receiver are arranged to establish data communication between the induction cookware and the one induction hob; and
the induction cooking system is configured to assign a cooking setting to the first cooking zone, and wherein the induction cooking system is further configured to automatically assign a corresponding cooking setting to the second cooking zone following a transferring of the induction cookware from the first cooking zone to the second cooking zone, wherein the induction cooking system is configured to automatically detect the transferring using sensor input provided by the one or more sensors of the induction cookware.

33. (canceled)

34. (canceled)

35. The induction cooking system according to claim 32, wherein the first cooking zone and the second cooking zone are different with respect to maximal inductive power and/or with respect to maximal inductive power density.

36. (canceled)

37. (canceled)

38. (canceled)

39. The induction cooking system according to claim 32, wherein the induction cookware comprises a wire loop for detecting changes in a magnetic field.

40. (canceled)

41. (canceled)

42. The induction cooking system according to claim 32, preceding claims, wherein the induction cooking system comprises a data processing arrangement configured to automatically detect a transfer of the induction cookware from the first cooking zone to the second cooking zone based on sensor input provided by the one or more sensors.

43. (canceled)

44. (canceled)

45. (canceled)

46. (canceled)

47. (canceled)
